(19) United States
(12) Patent Application Publication
(10) Pub. No.: US 2012/0151037 A1
(43) Pub. Date: Jun. 14, 2012

(54) Adaptive Download Bandwidth Allocation System, Apparatus and Method

(75) Inventors: John P. Kamieniecki, Lafayette Hill, PA (US); Albert F. Elcock, West Chester, PA (US)

(73) Assignee: GENERAL INSTRUMENT CORPORATION, Horsham, PA (US)

(21) Appl. No.: 12/964,954

(22) Filed: Dec. 10, 2010

(51) Int. Cl. G06F 15/173

(52) U.S. Cl. 709/224

(57) ABSTRACT

Apparatus for controlling the downloading conditions of software objects from a carousel server to a population of remotely-located, in-service, software-configurable consumer devices communicating via a network is disclosed. The apparatus includes an electronic controller programmed to automatically generate an announcement over the network to a target population of consumer devices. The announcement concerns the availability of a software object loaded for download on the carousel server. The controller receives replies from the target population of consumer devices and analyzes the replies to determine a quantity of the consumer devices in the target population that require the download and to determine an optimal allocation of bandwidth for the download based on information provided by the replies. A download system and method are also provided.

### FIELD

Apparatus for automatically updating software of a relatively-large population of remotely-located in-service electronic devices is disclosed and, more particularly, methods, apparatus and systems for updating software objects associated with a population of in-field consumer electronic devices operable in a broadband communication system, such as a subscription television system, are provided.

### BACKGROUND

Program providers such as multiple system operators, television networks and stations, studios, wireless service providers, and Internet broadcasters/service providers, among others, operate broadband communication systems, delivering programming to consumers over networks via digital or analog signals. Software-configurable consumer devices, such as set-top boxes, media centers, personal computers, and the like are adapted to receive and render delivered programming.

Software objects perform many basic functions of consumer devices, such as providing operating systems, application programs, user interfaces, and the like. For numerous reasons, existing software objects are regularly required to be replaced with updated or new software objects. By way of example, in a cable communication system, software objects associated with a set-top box that is in-service in the field may be updated via a network, such as a hybrid fiber-optic/coax network, by downloading of software objects from remote servers, such as download servers located at a headend of the network.

There are various methods for accomplishing software upgrades to set-top boxes or like devices in the field. In an on-demand type of download, each box or device requests and downloads software code or like objects or content via a dedicated connection (i.e. FTP, Ethernet, singlecast method, etc.). However, dedicating bandwidth and the rate at which a predetermined quantity of data can be transmitted in a given period of time to a single device is problematic when there are many devices deployed, such as tens of thousands to millions of set-top boxes or the like on a network.

Another alternative is a software carousel system in which code, objects, or like data is delivered or broadcast repeatedly in a continuous cycle on a given path. A set-top box or like device tunes to the data stream at any time and reconstitutes the data thereby permitting a single stream of data to be transmitted to a large number of devices simultaneously. The carousel system provides efficiencies with respect to bandwidth use in comparison to the single dedicated connection approach discussed above.

However, when many download objects are added to a carousel system, bandwidth must either be increased or the download rate decreased. A proper determination of the above typically requires manual intervention. In addition, it is often desirable to utilize different download rates at different times of the day to maximize network usage. Thus, management of objects on the carousel, bandwidth, and download rates require frequent manual system controller or operator intervention if the system is to continue to run in an optimal manner. In a typical carousel system in which bandwidth and download rates are set at fixed values and are not subject to frequent or regular optimization, such systems quickly become out of date and unavoidably suffer a loss of performance due to lack of intervention and maintenance.

Additional problems are also experienced since newer and different versions of devices, such as set-top boxes, are continually being created and placed in-service on the network along with existing older versions and different types of devices. This has the effect of greatly increasing the complexity of the download system over time since more and different types of objects are required to be placed on the carousel system. Thus, such a system is subjected to serious performance degradation.

Therefore, there is a need for methods, apparatus, and systems operable in a broadband communication system, such as a subscription television system, for efficiently updating or otherwise transmitting software, data, objects or the like to a relatively-large population of in-service consumer devices in the field.

### SUMMARY

This disclosure describes apparatus used to control downloads of software objects from a server to a population of remotely-located, in-service, software-configurable consumer devices communicating via a network. The apparatus includes an electronic controller having at least one microprocessor programmed to automatically generate an electronic announcement for transmission over the network to a target population of consumer devices. The announcement concerns the availability of a software object loaded for download on the carousel server. The at least one microprocessor is also programmed to receive replies to the announcement from the target population of consumer devices with respect to at least one of a need for download of the software object or current version of the objects loaded on the consumer devices. Further, the at least one microprocessor is programmed to automatically analyze the replies to determine a quantity of the consumer devices in the target population that require the download and to determine an optimal allocation of bandwidth for the download based on the replies.

This disclosure further describes a system including the above referenced controller in combination with a server.

Still further, this disclosure describes a method of controlling downloads of software objects from a server to a population of remotely-located, in-service consumer devices interconnected via a network. An electronic announcement is automatically generated by and transmitted from an electronic controller over the network to a target population of consumer devices concerning the availability of a particular software object or objects loaded for download on the server. After transmitting the announcement, the controller receives and accumulates replies to the announcement from the target population of consumer devices with respect to a need for download of the software object and/or the version of the software object loaded on each of the consumer devices. The controller automatically analyzes the accumulated replies to determine a quantity of the consumer devices in the target population that require the download and determines an optimal allocation of bandwidth for the download based on this information. After transmitting the announcement and receiving and analyzing the replies, the controller automatically adjusts the allocation of bandwidth for download of the software object over the network via the carousel server to the optimal allocation of bandwidth.

### BRIEF DESCRIPTION OF THE DRAWINGS

Various features of the embodiments described in the following detailed description can be more fully appreciated when considered with reference to the accompanying figures, wherein the same numbers refer to the same elements.

FIG. 1 is a schematic view of a simplified network having a head-end and/or distribution point and numerous devices in an in-service condition in the field;

FIG. 2 is a block diagram of a portion of the simplified network of FIG. 1;

FIG. 3 is a flowchart of a representative messaging sequence of a download process requiring device feedback; and

FIG. 4 is a flowchart of a download process in which allocation of bandwidth and the addition or elimination of code objects from a carousel are automatically controlled without significant manual intervention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

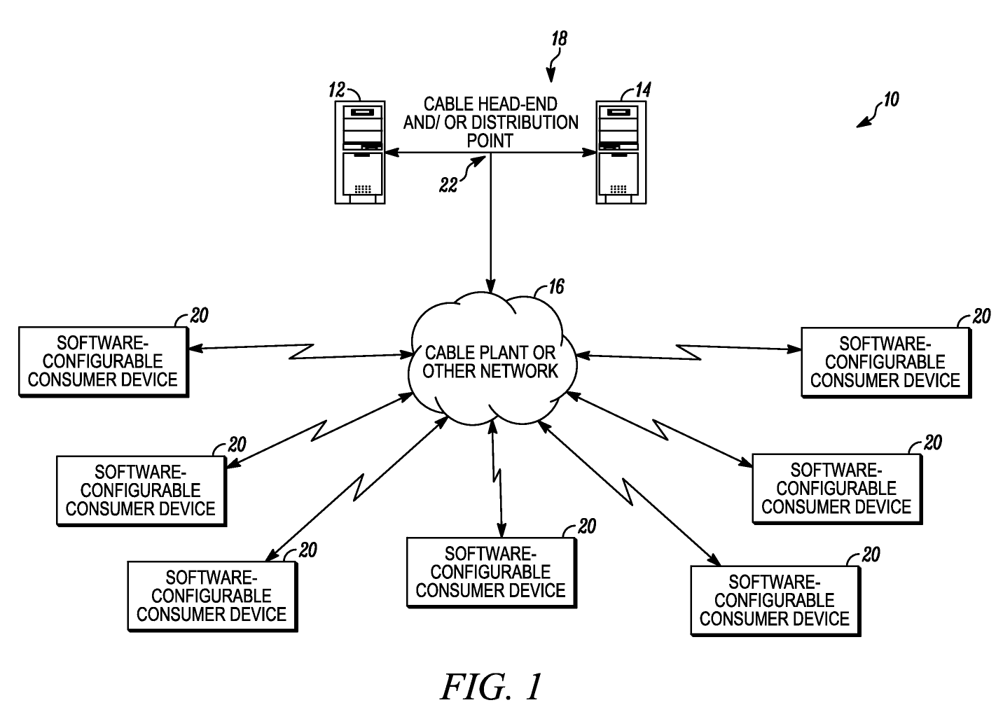

A simplified overview of a broadband communication system 10, such as a subscription television system or the like, is shown in FIG. 1. It should be understood that this disclosure is not limited to subscription television systems and has application to many different types of networks and public or private, wired or wireless, content transmission infrastructure or technology for delivery of content, including but not limited to a fiber-optic network, a coaxial cable network, a satellite network, a cellular network, a wireless network, the Internet, a television network, a radio network, a copper wire network, or any other transmission infrastructure or technology, or any combination thereof, operated by any type of program or like provider.

In FIG. 1, a controller 12 and a download server 14 are connected to network 16 at the head-end or distribution point 18 of the system 10. The controller 12 is the primary apparatus in head-end 18 that communicates with and controls operation of a population of remotely-located, in-service, software-configurable consumer devices 20 connected to the network 16. The controller 12 can also control operation of the download server 14. The download server 14 is a carousel server and is operative to produce software objects for download to the devices 20. In physical implementation, the controller 12 and server 14 may be the same device, different devices, or software applications running on the same device. The controller 12 and server 14 together can form a control system with respect to downloading software objects or the like.

The head-end 18 receives content and facilitates transfer of content to the consumer devices 20 in-service on the network 16. The content can be any pre-recorded or live analog or digital electronic signals representing an image and/or audio, software, or other data, in any format, to one or more of a plurality of the software-configurable consumer devices 20, such as a set-top boxes having software, objects 20a, or the like installed therein. The head-end 18 can also provide consumer services such as interactive television, Internet services, telephone services, video-on-demand services, and other services. The head-end 18 may include items such as servers which in turn include computer-readable storage media, microprocessors, processors, computer programs, and other items, configured in well-known manners using well-known techniques, to implement the functions of the head-end 18.

Application servers may be in communication with the head-end 18 to provide a variety of sources for content and/or services, such as interactive television, Internet services, telephone services, video-on-demand services, and the like. Channels, such as analog and digital upstream and downstream channels, are controlled by the head-end 22 using well-known methods and techniques. The channels are used to carry signals and data to and from the consumer devices 20, and the consumer devices 20 are able to tune to these channels.

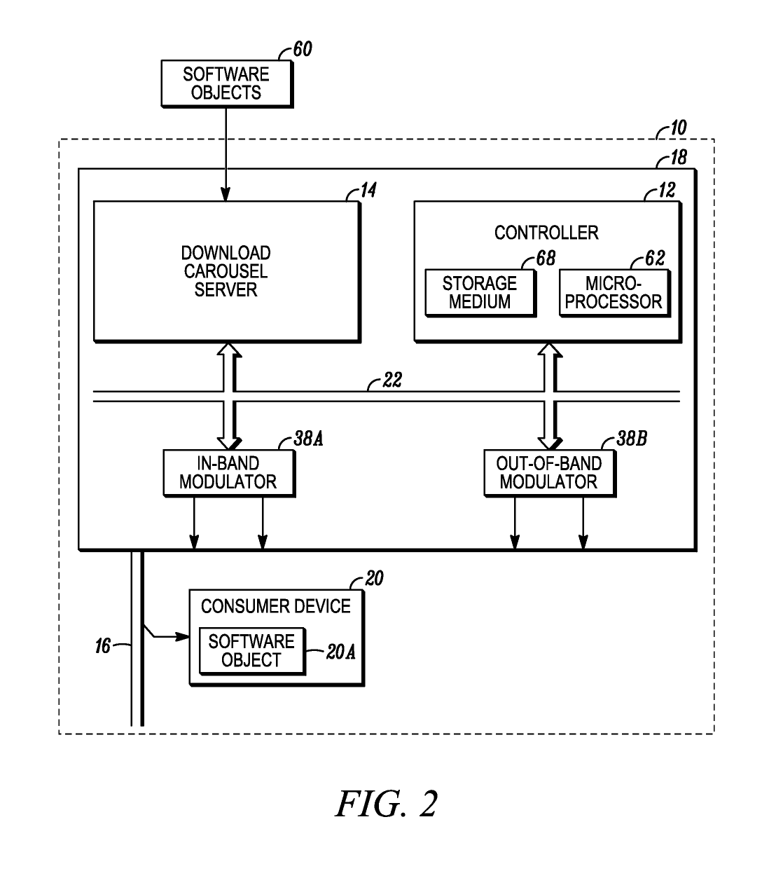

As illustrated in FIGS. 1 and 2, the electronic controller 12 and download carousel server 14 communicate with one another over a bus 22 that is located in the head-end 18. The controller 12 and download carousel server 14 are also in communication with at least one of an in-band modulator 38a and an out-of-band modulator 38b. Thus, signals or traffic from in-band modulator 38a and/or out-of-band modulator 38b may be transmitted to consumer device 20 on either a regular downstream channel or a specially identified control channel via the modulators 38a and 38b. Communication protocols utilized on a downstream control channel and a download channel may either be standard protocols or proprietary protocols, and any suitable transport streams may be used to carry communications, such as messages, from head-end 18 to consumer devices 20.

The in-band modulator 38a may receive data in various forms, including analog or digital video/audio content, control data, or download object data. In contrast, the out-of-band modulator 38b typically operates to provide software objects to consumer devices 20 for downloading, via a downstream channel. The downstream channel may be implemented using a data carousel, such as the Digital Storage Media-Command and Control (“DSM-CC”) Data Carousel, or the DSM-CC Object Carousel, based on international standard ISO/EEC 13818-6 for download object carousels.

The download carousel server 14, which may include one or more servers, is operative to communicate with controller 14 and consumer devices 20 and to perform certain aspects of the process of updating software objects associated with the consumer devices 20. The download carousel server 14 makes software objects 60, which may correspond to different devices and applications, continuously available for download via the in-band modulator and/or the out-of-band modulator on a data carousel. Different versions of software objects may be carouselled to accommodate different consumer devices 20 on the network 16. The controller 12 communicates the availability of, and information regarding, updated software objects 60 to the consumer devices 20. As shown in FIG. 2, the controller may include at least one microprocessor 62 and a storage medium 68.

Set-top devices 20 or like electronic consumer devices are connected to the network 16 and are in-service to receive and render delivered programming in the field at remote locations relative to the head-end 18. By way of example, the devices 20 can reside in homes throughout a community or multiple neighboring communities or regions. Typical devices 20 have the ability to communicate via a two-way communication path with the head-end 18. Accordingly, the devices 20 are able to receive data and the like from the head-end 18 via downstream communications and are able to transmit data and the like in a return path in an upstream direction on the network 16 back to the head-end 18.

As discussed above, existing software objects, data, code, content and the like 20a in the set-top boxes 20 are regularly required to be replaced, supplemented, and/or updated with newer software objects, data, code, content or the like 60 and a carousel downloading system can be utilized for this purpose. However, instead of manual addition and removal of objects 60 from the carousel and a fixed and/or manual allocation of bandwidth and download rates for a set of code objects, an automated process is utilized to automatically add and/or remove objects on the carousel for download at any given time and to adjust the bandwidth and rate of download employed at any given time or for any given object. For purposes of this application, the terms “object” or “objects” will refer to all software, code, data, content or other material that can be downloaded over the network 16 to the devices 20 via a carousel download system or streaming

While the download system may require some manual intervention for customization and to set up initial conditions, the system is otherwise intended to run in a dynamic fashion after set up and customization. Further manual changes to rule-sets or customization may still be accomplished; however, bandwidth adjustments are autonomous with the system and can remain autonomous for an extended period of time without the system suffering loss of performance.

Bandwidth for downloading objects is automatically monitored, controlled and optimized via the collection of data concerning download object interest or need or current version of loaded object from the population of devices 20 or a targeted population of the devices 20. This data can be collected via return-path communications and feedback received by controller 12 and/or carousel download server 14 at the head-end 18 from the population of devices 20 in-service on the network 16. The data can be collected, aggregated and analyzed before the download of a particular object or objects is initiated, during the download process, and/or after the download has been completed for some or all of the devices 20 in-service at any given point in time.

By pulling, receiving and accumulating the feedback data over an entire device population and over the entire download life cycle, the download system, 12 and 14, at the head-end 18 can make intelligent and automatic decisions to optimize download carousel bandwidth. Additionally, a set of smart operational rules can be added manually by an operator to allow customization of the download system to account for time varying or system varying needs. By way of example, if higher speeds of a given download object are needed at different times of the day for different days of the week, for instance, to accommodate field installers, these rules can be added to the download system, and the controller 12 will cause downloading to automatically compensate/adjust accordingly.

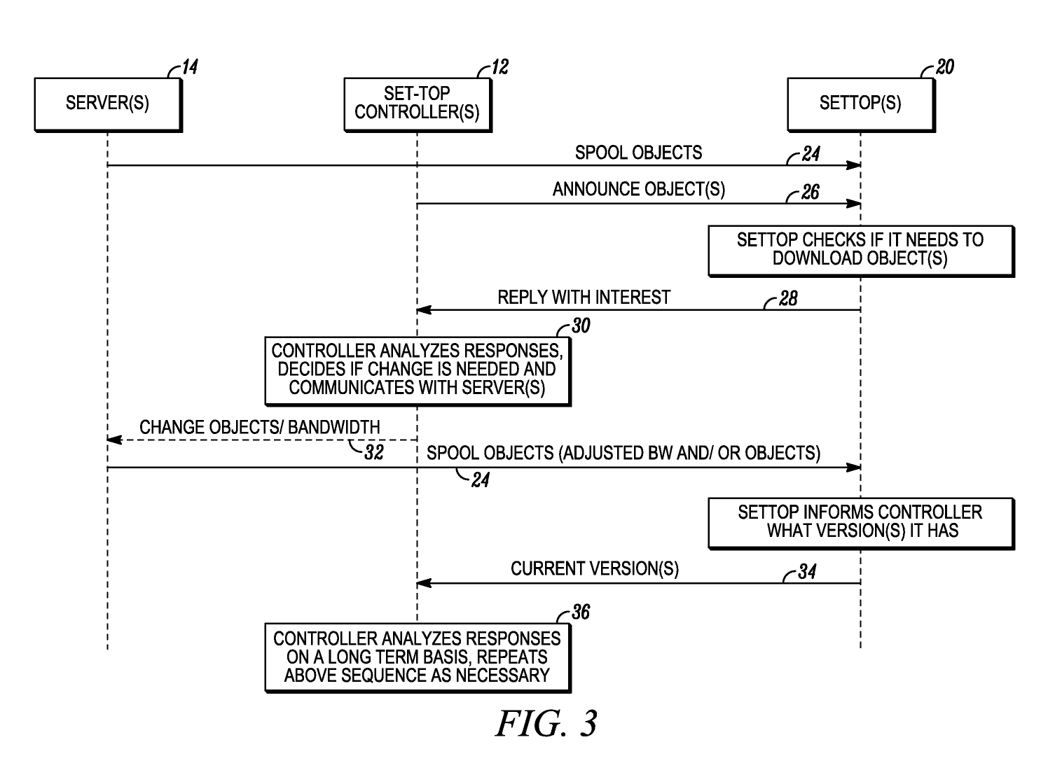

For purposes of example, FIG. 3 discloses a representative messaging sequence for use in the above referenced downloading system. For purposes of illustration, the controller 12 provides messaging to the set-top devices 20 over the network 16, receives responses from the devices 20 via return-path communications, and automatically makes decisions about bandwidth allocations and which object or objects should be added or removed from the carousel. The controller 12 then communicates the decisions to the download carousel server 14 which outputs (spools) the appropriate carousel of round robin download objects at the optimized bandwidths (see steps 24 in FIG. 3).

By way of example, the control system, 12 and 14, at any given point in time (before or after initial loading of the objects on the carousel) “announces” the availability of a given set of code objects 60 for download from the head-end 18. See messaging step 26 in FIG. 3. This announcement is by way of an electronically generated signal that can be generated and transmitted by the controller 12, more specifically, the at least one microprocessor 62. This code object or set 60 may be initially defined/configured manually on the download carousel system, or may be newly added by operation of the controller 12. The announcement may be broadcast to the entire population of devices 20, singlecast to an individual device 20, or multi-cast to a given range of devices 20 based on some type of target grouping, such as device type, version, address parameter, or the like. The controller 12 then “listens” for responses (see messaging step 28) sent from the selected device or population of devices 20 and accumulates “interest responses” or replies with respect to current versions of objects from the population of devices 20. The storage medium 68 can be used to store and accumulate information provided via the replies.

By aggregating this data over time and by periodically, continually or continuously automatically analyzing the aggregated data (see step 30), the controller 12 automatically adjusts and optimizes bandwidth allocations for each of the objects on the download carousel (see step 32), for either a fixed or variable bandwidth carousel server 14. The optimization of the bandwidth allocations can occur at predetermined increments of time such as measured in seconds, minutes, hours, or the like.

The controller 12 may also apply other smart rules that it has derived from the aggregated data or that have been manually entered by way of customization. For example, a system operator may prefer that “Code Object A” is always provided with a greater amount of bandwidth than “Code object B”, and this preference may change with respect to the time of day, day of month, or the like. The controller 12 uses the customized entries to automatically setup and control the carousel bandwidth. The “announce and accumulate interest response” process is optional for setting initial downloading conditions; however, if used, the process results can produce an efficient initial download condition. Of course, over time, as the process is repeated many times, the bandwidth is frequently adjusted to optimize levels automatically so that the download process never is subject to a loss of performance.

After a period of time has elapsed and objects 60 are successfully spooled to the devices 20 via the carousel (see steps 24), interested devices 20 will complete the download of a particular object or set of objects, as required. Upon completion of the download, each of the devices 20 that have completed a download sends a return-path signal to announce its current version of a particular object or set of objects (see messaging step 34), and the controller 12 accumulates and monitors this data to build up an accurate account of the population of devices 20 with respect to which have successfully downloaded the object or objects to date and which have not. This data can be used by the controller 12 to subsequently reduce or increase bandwidth for a particular object or set of objects as the process repeats (see step 36) and as the number of remaining interested devices 20 is reduced or changes. In addition, the controller 12 can use the data to automatically remove objects from the carousel should the controller 12 determine that there may no longer be any interested devices 20 currently in-service.

In the above download system, set-top devices 20 can announce their current version of objects at any time in the process (even before any initial downloads are configured). In many instances, some devices 20 may be off the network 16 at any given time for a variety of reasons, and so when they are rejoined to the network 16, the newly rejoined device 20 may send an announcement that indicates interest in a particular object or set of objects that has previously been removed from the carousel and is not currently loaded for transmission via the carousel. After receiving this interest response, the controller 12 can automatically add the requested object or objects to the carousel and allocate an appropriate amount of bandwidth based on the extent of interest or number of currently interested devices 20.

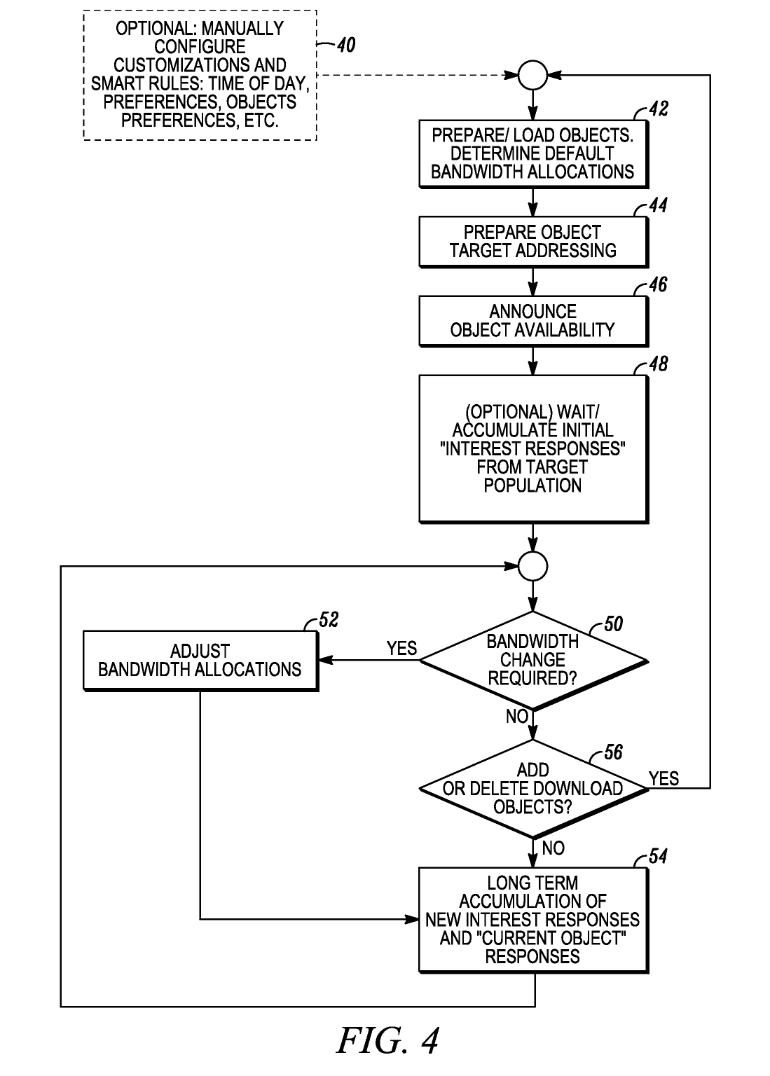

The operation of the controller 12 is best illustrated by the example disclosed in FIG. 4. An operator manually configures customizations and smart rules to be applied by the controller 12 during downloading procedures. See step 40. These customizations and smart rules can relate to time of day bandwidth requirements, downloading preferences to be applied among a group of objects, and the like. Thereafter, the controller 12 automatically prepares and causes loading of the objects 60 onto the download carousel server 14 and determines a default bandwidth allocation for each object or each set of objects. See step 42. The controller 12 determines which devices 20 within a population of devices 20 connected to the network 16 should be targeted and queried concerning the download. See step 44. The controller 12 then generates and transmits electronic announcements to all or an appropriate set of target devices 20 in a downstream direction on the network 16 from the head-end 18 to the devices 20 concerning the availability of the objects or set of objects 60. See step 46

If desired, the controller 12 can be set to wait or permit a predetermined period of time to lapse after making the announcement, or can wait for the receipt of a predetermined number of responses from the population of devices 20. See step 48. After this time elapses, the controller 12 determines whether the current bandwidth allocation is optimal based on the responses received and accumulated from the population of devices 20. See step 50. If the bandwidth allocation is determined appropriate by the controller 12, downloading of the objects and/or set of objects 60 can continue from the carousel 14 at the set allocated bandwidth. However, if more or less bandwidth should be allocated for a particular object or set of objects based on the number of responses received from the devices 20, the controller 12 automatically controls and causes a new amount of bandwidth to be allocated for the download by server 14. See step 52.

Over the course of time, the controller 12 continues to announce and receive responses from the devices 20 concerning the current version of the object or objects loaded on the devices, a need for an object or set of objects, or that the object or set of objects is up to date. This information is continually accumulated by the controller 12. See step 54. From any of this information, the controller 12 can automatically make frequent changes to the bandwidth allocation, as required, over the life-cycle of the download.

If the controller 12 determines that there is no more interest in a particular object or set of objects by the targeted devices 20, the controller 12 can automatically remove an object or set of objects from the carousel (see step 56) and repeat the above stated process starting from step 42 in FIG. 3. Alternatively, if the controller 12 receives interest for an object or set of objects not currently loaded on the carousel for download, the controller 12 can automatically add an object or set of objects to the carousel. See step 56.

Accordingly, an automated process is provided for adding and/or removing objects from the carousel for download at any given time and for adjusting and optimizing bandwidth and rate of download employed at any given time or for any given object. Bandwidth for downloading objects is automatically monitored, controlled and optimized via the collection of data concerning download object interest or need from the population of devices or a targeted population of the devices. The system can run in a dynamic fashion after set up and customization with bandwidth adjustments being autonomous with the system and remaining autonomous for an extended period of time without the system suffering loss of performance.

While the principles of the invention have been described above in connection with specific devices, systems, and methods, it is to be clearly understood that this description is made only by way of example and not as limitation on the scope of the invention as defined in the appended claims.

We claim:

1. Apparatus for controlling downloads of software objects from a server to a population of remotely-located, in-service consumer devices interconnected via a network, comprising:
an electronic controller having at least one microprocessor;
said at least one microprocessor being programmed to automatically generate an electronic announcement for transmission by said controller over the network to a target population of consumer devices, said announcement concerning availability of a software object loaded for download on a server;
said at least one microprocessor being programmed to receive replies to said announcement from the target population of consumer devices with respect to at least one of a need for download of the software object and a current version of the software object loaded on the consumer devices; and
said at least one microprocessor being programmed to automatically analyze the replies to determine a quantity of the consumer devices in the target population that require the download and to determine an optimal allocation of bandwidth for the download based on the replies.

2. Apparatus according to claim 1, wherein said at least one microprocessor of said electronic controller is programmed to repeatedly transmit said announcement, receive said replies, and determine said optimal allocation of bandwidth over the lifecycle of the software object.

3. Apparatus according to claim 1, wherein said electronic controller is in communication with a server and controls adjustments to the allocation of bandwidth with respect to the download of the software object to the target population from the server over the lifecycle of the software object.

4. Apparatus according to claim 3, wherein said electronic controller automatically controls loading and unloading of the software object onto and off of the server.

5. A system of controlling downloads of software objects from a server to a population of remotely-located, in-service consumer devices interconnected via a network, comprising:
an electronic controller having at least one microprocessor and being in communication with the server for controlling operation of the server;
said at least one microprocessor of the electronic controller being programmed to automatically generate an electronic announcement for transmission over the network to a target population of consumer devices, said announcement concerning availability of a software object loaded for download on the server;
said at least one microprocessor of the electronic controller being programmed to receive replies to said announcement from the target population of consumer devices with respect to at least one of a need for download of the software object and a current version of the software object loaded on the consumer devices; and
said at least one microprocessor of said electronic controller being programmed to automatically analyze the replies to determine a quantity of the consumer devices in the target population that require the download, to automatically determine an optimal allocation of bandwidth for the download, and to automatically adjust the allocation of bandwidth for the download by the server.

6. A system according to claim 5, wherein said at least one microprocessor of said electronic controller is programmed to repeatedly transmit said announcement, receive said replies, determine said optimal allocation of bandwidth, and adjust said allocation of bandwidth of the download of the software object over the lifecycle of the software object.

7. A system according to claim 5, wherein said electronic controller automatically controls loading and unloading of the software object onto and off of the server based on the replies.

8. A system according to claim 5, wherein the electronic controller and server is connected to a broadband communication network at a head-end of the network.

9. A system according to claim 8, wherein the consumer devices are software-configurable set top boxes in two-way communication with the head-end of the network, and wherein said announcement, replies, and download are transmitted over at least one predetermined channel of the broadband communication network to which said set top boxes can tune.

10. A method of controlling downloads of software objects from a server to a population of remotely-located, in-service consumer devices interconnected via a network, comprising the steps of:
automatically generating and transmitting an electronically-transmitted announcement from an electronic controller over the network to a target population of consumer devices concerning availability of a software object loaded for download on the server;
after said transmitting step, receiving and accumulating with the controller replies to the announcement from the target population of consumer devices with respect to at least one of a need for download of the software object and a current version of the software object loaded on the consumer devices;
automatically analyzing the replies with the controller to determine a quantity of the consumer devices in the target population that require the download and determining with the controller an optimized allocation of bandwidth for the download; and
after said transmitting, receiving and analyzing steps, automatically adjusting with the controller an allocation of bandwidth for download of the software object over the network via the server.

11. A method according to claim 10, further comprising the step of spooling the software object over the network via the server after said adjusting step.

12. A method according to claim 11, wherein said transmitting, receiving, analyzing, adjusting and spooling steps are repeated throughout the lifecycle of the software object.

13. A method according to claim 12, wherein, as said steps are repeated and as the quantity of consumer devices of the target population needing the download of the software object changes, the allocation of bandwidth is automatically reduced or increased by said analyzing and adjusting steps so that the allocation of bandwidth is continually and automatically optimized during the lifecycle of the software object.

14. A method according to claim 10, wherein said transmitting, receiving, analyzing, and adjusting steps are performed automatically without user intervention by the electronic controller.

15. A method according to claim 10, further comprising the step of automatically removing the software object from the server by said controller if, during said analyzing step, it is determined that none of the consumer devices in the target population require download of the software object.

16. A method according to claim 10, further comprising the step of automatically loading the software object onto the server by said controller if, during said analyzing step, it is determined that at least one of the consumer devices in the target population require download of the software object.

17. A method according to claim 10, wherein a predetermined period of time is permitted to lapse by said controller between said transmitting and adjusting steps to permit replies to be accumulated.

18. A method according to claim 10, further comprising the step of receiving with the controller information concerning a current version of the software object loaded on the consumer devices of the target population and storing such information for use by the controller during said analyzing step.

19. A method according to claim 10, further comprising the steps of receiving at least one of a customization setting or a smart rule setting by the controller and permitting the controller to automatically initially load the software object onto the server, determine the target population, and determine an initial allocation of bandwidth before said transmitting step.
